(19) United States
(12) Patent Application Publication
(10) Pub. No.: US 2024/0344623 A1
(43) Pub. Date: Oct. 17, 2024

(54) CONNECTING ROD SPRING DIAPHRAGM CHECK VALVE

(71) Applicant: Xiamen Koge Micro Tech Co., Ltd., Xiamen (CN)

(72) Inventor: Jihui YAN, Xiamen (CN)

(21) Appl. No.: 18/232,453

(22) Filed: Aug. 10, 2023

(30) Foreign Application Priority Data
Apr. 12, 2023 (CN) 202320807737.9

(51) Int. Cl. F16K 15/14

(52) U.S. Cl. CPC F16K 15/1481

(57) ABSTRACT

The present application relates to a field of a connection valve, in particular to a connecting rod spring diaphragm check valve, which includes a valve body, and the valve body is defined with an internal fluid channel; It also includes a control component, which includes a movable rod, the movable rod is provided inside the valve body to block the fluid channel; the movable rod is provided with a blocking plate, the blocking plate is configured to block the movable rod from the fluid medium.

### CROSS-REFERENCE TO RELATED APPLICATION

The present application claims the priority benefits of China patent application No. 202320807737.9, filed on Apr. 12, 2023. The entirety of China patent application No. 202320807737.9 is hereby incorporated by reference herein and made a part of this specification.

### TECHNICAL FIELD

The present application relates to a technical field of connection valve, and in particular, relates to a connecting rod spring diaphragm check valve.

### BACKGROUND ART

A check valve is a valve used to control a flow direction of a fluid medium, which can prevent a reverse flow of the fluid in a pipeline. A fluid channel is provided in a commonly used check valve. When the check valve is opened, the fluid is transported from an inlet end of the fluid channel to an outlet end of the fluid channel. A hardware is provided in the check valve fluid channel for avoiding the reverse flow of the fluid in the fluid channel. When the fluid is transported normally, the inlet end of the fluid channel is communicated to the outlet end of the fluid channel; when the reverse flow occurs, the hardware separates the inlet end and the outlet end of the fluid channel.

The check valve may be in a normally open state in some working environments. However, when the check valve is exposed to a relatively moist environment for a long time, especially when the pipeline is used to transport corrosive fluids, the hardware is easy to corrode by a liquid, which affects a service life of the check valve.

### SUMMARY

In order to reduce an erosion of an external fluid on the interior of a check valve and improve a service life of the check valve, the present application provides a connecting rod spring diaphragm check valve.

A connecting rod spring diaphragm check valve provided in the present application adopts the following technical solution:

A connecting rod spring diaphragm check valve comprises a valve body, in which a fluid channel is provided; and a control component, wherein the control component comprises a movable rod, which is provided in the valve body for blocking the fluid channel; the movable rod is provided with an elastic blocking plate that is configured to block the movable rod from a fluid medium.

By adopting the above technical solution, when the check valve switches from an open state to a closed state, the movable rod blocks the fluid channel; the blocking plate provided on the movable rod can block the movable rod from the fluid medium, thereby reducing a possibility of the control component being corroded by a liquid and extending a service life of the check valve.

In an example, the blocking plate is configured to separate the fluid channel into a reflux cavity and a communication cavity, the valve body is provided with a first channel for the fluid medium to enter the valve body and a second channel for the fluid medium to flow out of the valve body, and both the first channel and the second channel are communicated to the reflux cavity; the movable rod is provided in the communication cavity, and an end of the movable rod abuts against a side of the blocking plate departing from the reflux cavity, the blocking plate adopts an elastic material.

By adopting the above technical solution, when the check valve is in the open state, the fluid medium enters the reflux cavity from the first channel and then flows out of the valve body through the second channel; when the check valve switches from the open state to the closed state, the control component drives the elastic material blocking plate to undergo an elastic deformation and buckle into the reflux cavity, causing the blocking plate to block the first channel and the second channel, the blocking plate always blocks the fluid medium in the reflux cavity, thereby reducing a possibility of a contact between the fluid medium and the control component and extending the service life of the check valve.

In an example, the convex ring is configured to encircle an opening of the second channel facing the reflux cavity; the convex ring is arranged on an moving path of the movable rod, and the convex ring is configured to cooperate with the movable rod such that, when the valve body is closed, the blocking plate abuts against a side wall of the convex ring departing from the inner wall of the reflux cavity.

By adopting the above technical solution, the convex ring facilitates the control component to isolate and tighten the blocking plate against the fluid channel, when the check valve is switched to the closed state, the movable rod pushes the blocking plate towards the direction departing from the valve seat, making the blocking plate closely fit with the side wall of the convex ring departing from the inner wall of the reflux cavity; the convex ring protrudes from the inner wall of the reflux cavity, which can reduce a distance that the movable rod needs to move when the check valve transitions from the open state to the closed state, thereby reducing an energy required by the control component to control the opening and closing of the check valve, and improving a convenience of the control component in controlling the opening and closing of the check valve.

In an example, a mounting cavity is provided in the valve body, the mounting cavity is configured for mounting the control component; the mounting cavity is communicated with an end of the communication cavity departing from the blocking plate; and
the control component includes an electromagnet and an iron sheet adapted to the electromagnet; the electromagnet is fixedly connected to an inner wall of the mounting cavity, and the movable rod is detachably connected to an end of the iron sheet departing from the elastic blocking plate.

By adopting the above technical solution, after the electromagnet is energized, the electromagnet generates a magnetic force that can attract the iron sheet to move in the direction facing the convex ring, during the movement, the iron sheet drives the movable rod to move synchronously; at the same time, the side wall of the blocking plate undergoes an elastic deformation under a thrust of the movable rod, causing the side wall of the blocking plate to highly fit the side wall of the convex ring, blocking the first channel and the second channel.

In an example, an end of the movable rod departing from the blocking plate is provided with a snap-fit, a limit hole adapted to the snap-fit is provided on the iron sheet, and the snap-fit passes through the limit hole and snaps on an inner wall of the limit hole.

By adopting the above technical solution, the inner wall of the limit hole is clamped with the snap-fit, so that the movable rod and the iron sheet can form an integral whole, thereby improving a stability between the movable rod and the iron sheet.

In an example, a spring is sleeved on the movable rod, a first end of the spring is fixedly connected to the end of the movable rod departing from the elastic blocking plate, and a second end of the spring is fixedly connected to an inner wall of the mounting cavity facing the reflux cavity.

By adopting the above technical solution, when the electromagnet is energized, the iron sheet pulls the spring and the movable rod towards the direction facing the valve head, and the spring is compressed; when the electromagnet is powered off, the spring and the blocking plate simultaneously reset and pull the movable rod and the iron sheet to move departing from the valve head; a rebound of the spring causes an additional pulling force on the movable rod, which facilitates the reset of the movable rod and the blocking plate.

In an example, the valve body includes a valve seat and a valve head, the valve seat is detachably connected to the valve head, the control component is provided in the valve seat, and the elastic blocking plate is provided between the valve seat and the valve head.

By adopting the above technical solution, the valve head and the valve seat are provided separately and can be detachably connected, which facilitates an assembly of the check valve by working personnel and facilitates a replacement of an internal part of the check valve by working personnel.

In an example, the blocking plate is detachably connected to a side wall of the valve head facing the valve seat.

By adopting the above technical solution, a connection between the blocking plate and the valve head can improve the stability between the blocking plate and the valve head, the detachable connection between the blocking plate and the valve head facilitates the replacement of the blocking plate by working personnel.

In summary, the present application includes at least one of the following beneficial technical effects:
1. After the electromagnet is energized, it drives the movable rod and the iron sheet to simultaneously apply pressure to the blocking plate, forcing it to undergo the elastic deformation, so that the side wall of the blocking plate is highly fit to the side wall of the convex ring departing from the reflux cavity, blocking the first channel and the second channel, the check valve switches from the open state to the closed state; after the electromagnet is powered off, the blocking plate and the spring simultaneously reset and drive the movable rod and the iron sheet to return to their original positions, the check valve switches from the closed state to the open state, and the fluid enters from the first channel and flows out from the second channel through the reflux cavity, achieving the transmission of the fluid by the check valve.

The blocking plate can block the liquid flowing back into the check valve in the reflux cavity, thereby reducing the possibility of the liquid flowing back into the check valve coming into contact with the iron sheet and the electromagnet, thereby reducing the possibility of the control component being corroded by the liquid and extending the service life of the check valve.

### BRIEF DESCRIPTION OF THE DRAWINGS

FIG. 1 is a vertical view of a connecting rod spring diaphragm check valve according to an embodiment 1 of the present application;

FIG. 2 is a schematic cross-sectional view taken along a line A-A in FIG. 1, in which a valve body is in an open state;

FIG. 3 is a schematic cross-sectional view taken along a line B-B in FIG. 1;

FIG. 4 is a schematic explosion view of the connecting rod spring diaphragm check valve according to the embodiment 1 of the present application;

FIG. 5 is a schematic three-dimensional view of a assembled connecting rod spring diaphragm check valve according to the embodiment 1 of the present application;

FIG. 6 is a schematic cross-sectional view taken along a line A-A in FIG. 1, in which the valve body is in a closed state;

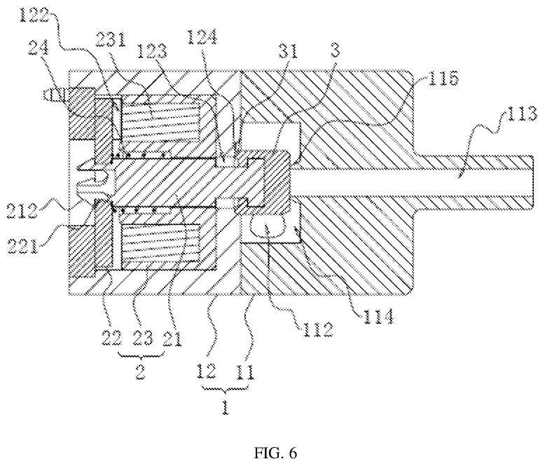

FIG. 7 is a schematic cross-sectional view of the valve body along its lengthwise axis according to embodiment 2 of the present application.

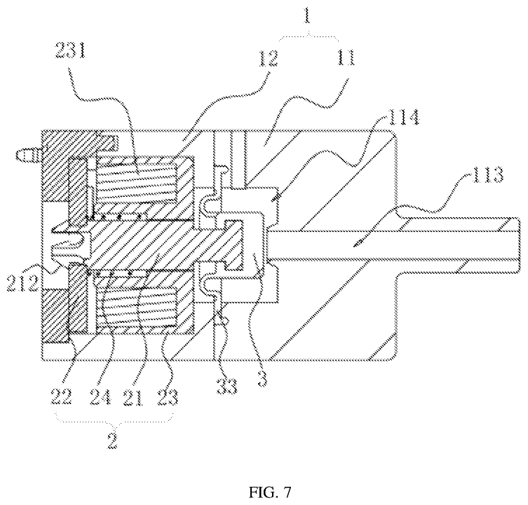

### DETAILED DESCRIPTION

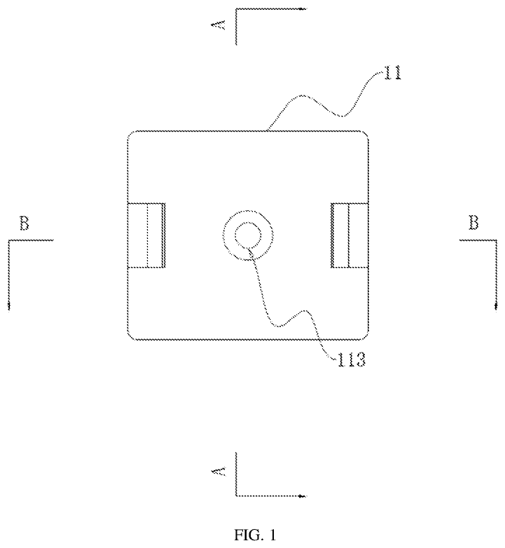

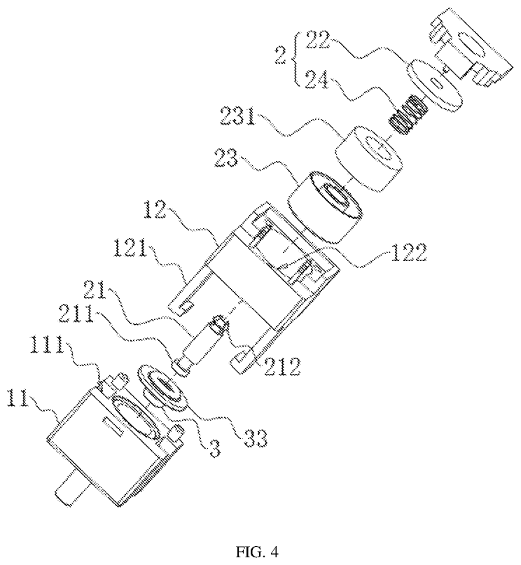

The present application is further described in detail below with reference to FIGS. 1-5.

A connecting rod spring diaphragm check valve is provided according to embodiments of the present application.

### Embodiment 1

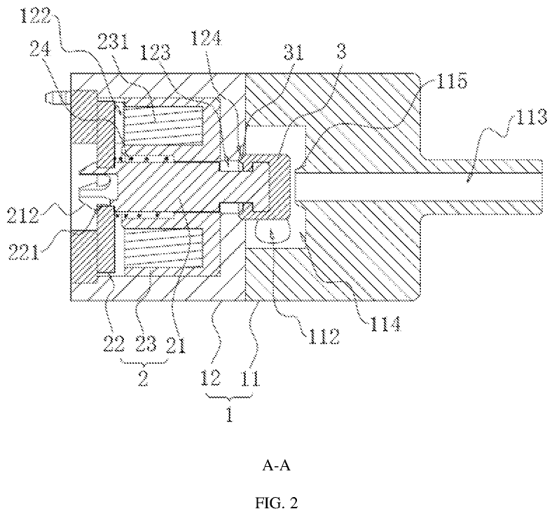

Referring to FIGS. 1 and 2, a connecting rod spring diaphragm check valve includes a valve body 1 with an internal fluid channel and a control component 2 for opening and closing the check valve, the control component 2 is provided inside the valve body 1. The valve body 1 includes a valve head 11 and a valve seat 12, in the embodiment, the fluid channel is provided on the valve head 11, and the control component 2 is installed on the valve seat 12. The valve head 11 and the valve seat 12 can be detachably connected to facilitate an assembly of the control component 2 inside the valve body 1 by working personnel. A blocking plate 3 is provided between the valve head 11 and the valve seat 12, the blocking plate 3 can block the control component 2 from the fluid medium, thereby reducing a possibility of corrosion of the control component 2 and extending a service life of the check valve.

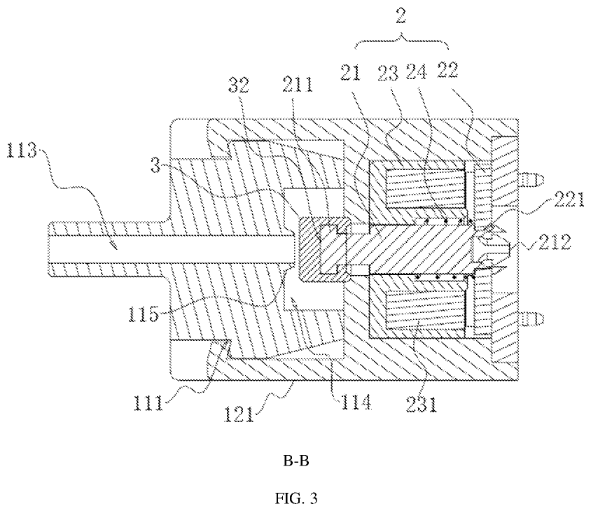

Referring to FIG. 3, in the embodiment, several snap strips 121 are protruded on a side wall of the valve seat 12, and a plurality of snap-in slots 111 corresponding to the snap strips 121 are provided on the valve head 11; the snap strip 121 is made of elastic material, which facilitates the working personnel to buckle the snap strip 121 into the snap-in slot 111 during assembly, achieving a limit fixation between the valve head 11 and the valve seat 12. There are two snap strips 121 in the embodiment, which are symmetrically provided on both sides of the side wall in a length direction of the valve seat 12.

Referring to FIG. 2, the valve head 11 is provided with a first channel 112 for the fluid medium to enter the valve body 1 and a second channel 113 for the fluid medium to flow out of the valve body 1, a reflux cavity 114 is provided on a side of the valve head 11 facing the valve seat 12, and both the first channel 112 and the second channel 113 are communicated with the reflux cavity 114. In the embodiment, the first channel 112 is arranged on a side wall of the valve head 11, the second channel 113 is arranged on a side wall of an end of the valve head 11 departing from the valve body 1, and an extension direction of the second channel 113 is consistent with a length direction of the valve body 1.

In the embodiment, the blocking plate 3 is made of alloy elastic steel. The blocking plate 3 made of alloy elastic steel has a high elastic limit and a stable property; it is not easy to rust in a liquid immersion environment, thereby reducing a possibility of rust on the blocking plate 3 due to prolonged contact with the liquid, thereby extending the service life of the check valve.

Referring to FIG. 2, when the check valve is in an open state, the fluid enters the reflux cavity 114 from the first channel 112 and flows to an outside of the valve body 1 through the second channel 113, achieving a transportation of the fluid by the check valve. When the check valve switches from the open state to the closed state, the control component 2 drives the blocking plate 3 to buckle into the reflux cavity 114, so that the blocking plate 3 contacts an opening of the second channel 113 facing the reflux cavity 114, the check valve switches from the open state to the closed state.

Referring to FIGS. 2 and 3, a mounting cavity 122 for mounting the control component 2 is provided at an end of the valve seat 12 departing from the valve head 11. The control component 2 includes a movable rod 21; a length direction of the movable rod 21 is consistent with the length direction of the valve body 1. A communication cavity 123, which is connected to the mounting cavity 122, is provided at an end of the valve seat 12 facing the valve head 11; the movable rod 21 passes through the communication cavity 123 and is slidably connected to the inner wall of the communication cavity 123, and the blocking plate 3 covers an opening of the communication cavity 123 at one end departing from the mounting cavity 122. A snap ring 31 is protruded on one side facing the communication cavity 123 of the blocking plate 3, and an axis of the snap ring 31 is collinear with an axis of the blocking plate 3; a ring slot 124, which is adapted to the snap ring 31, is provided on an inner wall of the communication cavity 123 departing from a side of the mounting cavity 122, the snap ring 31 is transitionally fit with an inner wall of the ring slot 124. During installation, the snap ring 31 is buckled into the ring slot 124, so that the blocking plate 3 and the valve seat 12 can form an integral whole, thereby increasing a stability between the blocking plate 3 and the valve seat 12, and reducing a looseness between the blocking plate 3 and the side wall of the valve seat 12, which can lead to an infection of the control component 2 by the fluid medium.

Referring to FIG. 3, a snapping part 211 is protruded on an end of the movable rod 21 facing the valve head 11, and the blocking plate 3 is inwardly concave towards the side departing from the valve seat 12 to form a mounting slot 32 that is suitable for the snapping part 211. During installation, the snapping part 211 is buckled into the mounting slot 32, and the snapping part 211 is clamped with an inner wall of the mounting slot 32, so that the blocking plate 3 and the movable rod 21 can form an integral whole, thereby improving stability between the blocking plate 3 and the movable rod 21.

Referring to FIG. 3, the control component 2 also includes an iron sheet 22 and an electromagnet 23, in the embodiment the iron sheet 22 can slide back and forth along an extension direction of the mounting cavity 122 in the mounting cavity 122; the electromagnet 23 is fixedly connected on the inner wall of the mounting cavity 122 facing the side of the communication cavity 123, and the movable rod 21 is connected to the iron sheet 22 at one end departing from the blocking plate 3. When the check valve is in the open state, there is a gap between the iron sheet 22 and the electromagnet 23.

Referring to FIG. 3, the electromagnet 23 is fixedly connected on the inner wall of the mounting cavity 122 facing the side of the communication cavity 123, in the embodiment, the electromagnet 23 is provided in a circular shape, and the electromagnet 23 is centered around the axis of the movable rod 21 and the electromagnet 23 is provided inside the valve seat 12. The inner wall of the electromagnet 23 is embedded with a coil 231, which is connected to an external power source; after the coil 231 is energized, the electromagnet 23 generates a magnetic force that can attract the iron sheet 22 to move in the direction facing the valve head 11, during the movement, the iron sheet 22 drives the movable rod 21 to move synchronously; at the same time, the side wall of the blocking plate 3 undergoes an elastic deformation under a thrust of the movable rod 21, causing the side wall of the blocking plate 3 to highly fit the side wall of the reflux cavity 114 facing the second channel 113, blocking the first channel 112 and the second channel 113.

Referring to FIG. 3, a snap-fit 212 is protruded on an end of the movable rod 21 departing from the blocking plate 3, the iron sheet 22 is penetrated with a limit hole 221 that is suitable for the snap-fit 212, the limit hole 221 can be configured for the snap-fit 212 to buckle in, and an axis of the limit hole 221 is collinear with an axis of the iron sheet 22; the snap-fit 212 is made of elastic material which facilitates the snap-fit 212 buckle into the limit hole 221; an inner wall of the limit hole 221 is clamped with an outer wall of the snap-fit 212, so that the movable rod 21 and the iron sheet 22 can form an integral whole, thereby improving a stability between the movable rod 21 and the iron sheet 22.

Referring to FIG. 3, a spring 24 is sleeved on an outer coaxial of the movable rod 21, one end of the spring 24 is fixedly connected to the side wall of the mounting cavity 122 facing the communication cavity 123, and the other end of the spring 24 is fixedly connected to the side wall of the iron sheet 22 facing the electromagnet 23. When the electromagnet 23 is energized, the iron sheet 22 pulls the spring 24 and the movable rod 21 towards the direction facing the valve head 11, and the spring 24 is compressed; when the electromagnet 23 is powered off, the spring 24 and the blocking plate 3 simultaneously reset and pull the movable rod 21 and the iron sheet 22 to move departing from the valve head 11; a rebound of the spring 24 causes an additional pulling force on the movable rod 21, which facilitates the reset of the movable rod 21.

Referring to FIG. 2, a convex ring 115 is protruded on the side wall of the second channel 113 facing the opening of one end of the reflux cavity 114, and an axis of the convex ring 115 is collinear with an axis of the second channel 113, the convex ring 115 is provided on a moving path of the movable rod 21; when the check valve switches to the closed state, the movable rod 21 pushes the blocking plate 3 to move departing from the valve seat 12, so that the blocking plate 3 is closely fit with the side wall of the convex ring 115 departing from the second channel 113.

In the embodiment, an outer diameter of the convex ring 115 is smaller than a diameter of the blocking plate 3, thereby reducing a contact area between the blocking plate 3 and the reflux cavity 114 when sealing the second channel 113; when a thrust force of the movable rod 21 on the blocking plate 3 is the same, it can increase a pressure on the side wall at the opening of the second channel 113, making a blocking effect of the blocking plate 3 on the second channel 113 better.

In addition, the convex ring 115 protrudes from the inner wall of the reflux cavity 114, which can reduce a distance that the movable rod 21 needs to move when the check valve switches from the open state to the closed state, thereby reducing an energy required by the control component 2 to control the opening and closing of the check valve, and improving a convenience of the control component 2 in controlling the opening and closing of the check valve.

An implementation principle for embodiment 1 is: after the electromagnet 23 is energized, it attracts the iron sheet 22, causing the iron sheet 22 to move in the direction facing the valve head 11, and the spring 24 is compressed; the movable rod 21 moves synchronously with the iron sheet 22 to apply pressure to the blocking plate 3, forcing it to undergo the elastic deformation; the side wall of the blocking plate 3 is highly fit to the side wall of the convex ring 115 departing from the reflux cavity 114, blocking the first channel 112 and the second channel 113, the check valve switches from the open state to the closed state.

After the electromagnet 23 is powered off, a magnetism disappears, the blocking plate 3 and the spring 24 reset simultaneously, driving the movable rod 21 and the iron sheet 22 to return to their original positions, the check valve switches from the closed state to the open state, and the fluid medium enters from the first channel 112 and flows out from the second channel 113 through the reflux cavity 114, achieving a transmission of the fluid medium by the check valve.

The blocking plate 3 can block the liquid flowing back into the check valve in the reflux cavity 114, thereby reducing the possibility of the liquid flowing back into the check valve coming into contact with the iron sheet 22 and the electromagnet 23, thereby reducing the possibility of the control component 2 being corroded by the liquid and extending the service life of the check valve.

### Embodiment 2

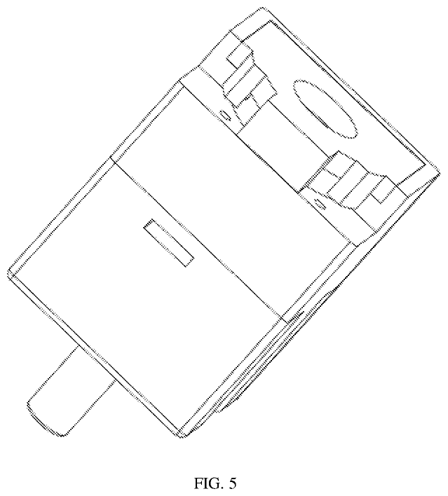

Referring to FIG. 5, a difference between embodiment 2 and embodiment 1 is that, the outer edge of the blocking plate 3 is surrounded by a folded edge 33, which is coaxial with the blocking plate 3, and the folded edge 33 is integrated with the blocking plate 3, the folded edge 33 is embedded in the end wall of the valve head 11 facing the valve seat 12. In the embodiment, both the blocking plate 3 and the folded edge 33 adopts the elastic material; in the embodiment, both the blocking plate 3 and the folded edge 33 are made of alloy elastic steel. The folded edge 33 provided on the outer edge of the blocking plate 3 can increase the area of contact between the blocking plate 3 and the side walls of the valve head 11 and the valve seat 12, thereby improving the stability between the blocking plate 3 and the valve body 1, reducing the possibility of a direct contact between the fluid medium and the control component 2, and extending the service life of the check valve.

The above are the preferred embodiments of the present application, which are not intended to limit the protection scope of the present application. Therefore, all equivalent changes made according to the structure, shape and principle of the present application should be covered within the protection scope of the present application.

### LIST OF REFERENCE SIGNS

1. valve body
11. valve head
111. snap-in slot
112. first channel
113. second channel
114. reflux cavity
115. convex ring
12. valve seat
121. snap strip
122. mounting cavity
123. communication cavity
124. ring slot
2. control component
21. movable rod
211. snapping part
212. snap-fit
22. iron sheet
221. limit hole
23. electromagnet
231. coil
24. spring
3. blocking plate
31. snap ring
32. mounting slot
33. folded edge

What is claimed is:

1. A connecting rod spring diaphragm check valve, comprising: a valve body, in which a fluid channel is provided; and a control component, wherein the control component comprises a movable rod, which is provided in the valve body for blocking the fluid channel; the movable rod is provided with an elastic blocking plate that is configured to block the movable rod from a fluid medium; the elastic blocking plate separates the fluid channel into a reflux cavity and a communication cavity; a convex ring is convexly provided on an inner wall of the reflux cavity; the valve body is provided with a first channel for the fluid medium to enter the valve body and a second channel for the fluid medium to flow out of the valve body; both the first channel and the second channel are in communication with the reflux cavity; the movable rod is provided in the communication cavity, and an end of the movable rod abuts against a side of the elastic blocking plate departing from the reflux cavity.

2. The connecting rod spring diaphragm check valve according to claim 1, wherein the convex ring is configured to encircle an opening of the second channel facing the reflux cavity; the convex ring is arranged on a moving path of the movable rod and is configured to cooperate with the movable rod such that, when the valve body is closed, the elastic blocking plate abuts against a side wall of the convex ring departing from the inner wall of the reflux cavity.

3. The connecting rod spring diaphragm check valve according to claim 1, wherein a mounting cavity is provided in the valve body, the mounting cavity is configured for mounting the control component; the mounting cavity is in communication with an end of the communication cavity departing from the elastic blocking plate; and
the control component comprises an electromagnet and an iron sheet adapted to the electromagnet; the electromagnet is fixedly connected to an inner wall of the mounting cavity, and the movable rod is detachably connected to an end of the iron sheet departing from the elastic blocking plate.

4. The connecting rod spring diaphragm check valve according to claim 3, wherein an end of the movable rod departing from the elastic blocking plate is provided with a snap-fit, a limit hole adapted to the snap-fit is provided on the iron sheet, and the snap-fit passes through the limit hole and snaps on an inner wall of the limit hole.

5. The connecting rod spring diaphragm check valve according to claim 3, wherein a spring is sleeved on the movable rod, a first end of the spring is fixedly connected to an end of the movable rod departing from the elastic blocking plate, and a second end of the spring is fixedly connected to an inner wall of the mounting cavity facing the reflux cavity.

6. The connecting rod spring diaphragm check valve according to claim 1, wherein the valve body comprises a valve seat and a valve head; the valve seat is detachably connected to the valve head, the control component is provided in the valve seat, and the elastic blocking plate is provided between the valve seat and the valve head.

7. The connecting rod spring diaphragm check valve according to claim 6, wherein the elastic blocking plate is detachably connected to a side wall of the valve head facing the valve seat.
